(19) United States
(12) Patent Application Publication
(10) Pub. No.: US 2021/0060863 A1
(43) Pub. Date: Mar. 4, 2021

(54) Device and Method for Producing a Component by Means of 3D Multi-Material Printing and Component Produced Therewith

(71) Applicant: Technische Universität Chemnitz, Chemnitz (DE)

(72) Inventors: Johannes Rudolph, Bad Lausick (DE); Fabian Lorenz, Chemnitz (DE); Ralf Werner, Chemnitz (DE)

(21) Appl. No.: 16/643,852

(22) PCT Filed: Aug. 24, 2018
(86) PCT No.: PCT/DE2018/100733

§ 371 Date: Mar. 3, 2020

(30) Foreign Application Priority Data
Sep. 8, 2017 (DE) 10 2017 120 750.3

(51) Int. Cl. B29C 64/393; B29C 64/165; B29C 64/209; B29C 64/336; B22F 3/00; B28B 1/00; B28B 17/00; B33Y 10/00; B33Y 30/00; B33Y 50/02; B33Y 70/10

(52) U.S. Cl. CPC B29C 64/393; B29C 64/165; B29C 64/209; B29C 64/336; B22F 3/008; B33Y 70/10; B28B 17/0072; B33Y 10/00; B33Y 30/00; B33Y 50/02; B28B 1/001

(57) ABSTRACT

The invention relates to a method and a device for producing a component by means of 3D multi-material pressure and to a component part produced therewith, wherein metallic and ceramic pastes, mixed with powder and binding agents, for producing the component are applied in layers by means of an extrusion process and are shaped, and the printing process is monitored by means of a monitoring device in such a way that defects in the pressure are detected by means of a camera and the defects are eliminated and/or overfilling or underfilling of each printed layer in relation to the extrusion quantity is monitored by means of a camera and/or temporary blockages in the extrusion nozzle are detected by monitoring the pressure in the region of the extrusion nozzle and released by increasing the pressure. The device comprises a corresponding monitoring device. The device can also have a mixing and feeding device with a vacuum mixing container which is connected to a vibration device. The device can comprise a ceramic construction platform having a porous structure. The component has a lattice structure with beads which are deposited at a distance from one another on a plane.

### CROSS REFERENCE TO RELATED APPLICATIONS

This application is the U.S. national stage of International Application No. PCT/DE2018/100733, filed on 2018 Aug. 24. The international application claims the priority of DE 102017120750.3 filed on 2017 Sep. 8; all applications are incorporated by reference herein in their entirety.

### BACKGROUND

The invention relates to a device and a method for producing a component made of several materials by means of 3D multi-material printing as well as a manufactured component and is used in particular for the manufacture of a printed electrical component, in particular an electric motor.

From the publication EP 1639871 B1, a method for producing an electrically conductive pattern by printing a layer comprising metal oxides is known. The layer is transferred to an application substrate as a reduced layer. After printing, the conductive pattern is heated by infrared or microwave irradiation for metallization and sintering. The electrically conductive pattern is in the form of a paste layer and is produced by screen printing, pad printing, flexo printing, gravure printing, litho printing, inkjet or laser printing.

US 2016/0325498 A1 describes a 3D printer with a two-stage nozzle that deposits each layer in a grid. Each nozzle has an individually controllable high-speed valve, wherein a molten plastic is fed to several nozzles under constant pressure.

In WO 2016/115 095 A1 it is disclosed that the materials used during the AM process may be metal alloy(s), photopolymer, thermoplastics, eutectic metals, edible materials, rubbers, modelling and/or metal clay, ceramic materials, powdered polymers, thermoplastic powder, ceramic powder, paper, metal foil, plastic film. The AM process can build the component 2 and/or one or more subsequent components based on one or more 3D computer models in one or more printable file formats selected from, but not limited to, STL file format, WRL file format, VRML. Also possible are 3MF file format, AMF file format, ZPR file format, FORM file format and Gcode file format. The AM process can be used to build the component 2 for one or more of the following applications: manufacturing applications; industrial applications; socio-cultural applications; and/or any combination thereof. In embodiments, manufacturing applications may be related to or targeted at distributed manufacturing, mass customization, rapid manufacturing, rapid prototyping, research, food, medical application, custom medical castings and/or any combination thereof.

It is further known from this publication to provide a verification and adjustment method for correcting at least one design error present in a component built by additive manufacturing, wherein the method comprises the following: extracting 3D digital geometry data of the component from collected digital data, wherein the collected digital data is based on the assembled component, a build platform of an additive manufacturing device, wherein the collected digital data comprise 2D digital images collected by a first imaging device associated with the additive manufacturing device and 3D digital images collected by a second imaging device associated with the additive manufacturing device; detecting at least one build error in the component being built on the build platform by comparing the extracted 3D digital geometry data with a first 3D digital model of the component, wherein a first 3D printable digital file of the component comprises the first 3D digital model of the component; generating a second 3D digital model of the component based on the detected at least one build error present in the component, wherein the second 3D digital model takes into account or corrects the detected at least one build error present in the component; and providing a second 3D digital printable file that takes into account or corrects the detected at least one build error by modifying the line-by-line code of the first 3D digital printable file to integrate the generated second 3D digital model of the component.

With this prior art D1 solution, errors in the print are detected, but are only corrected in the subsequent printing process/layer.

In US 2016/0009 029 A1 it is disclosed that various thermoplastic materials and thus only plastics are melted through a nozzle. The material can be discharged by means of a piston. In yet other embodiments, material can be fed into the MMC when the piston is lifted. In this process, a vacuum is generated when the piston is lifted. This vacuum caused by the lifting of the piston should be reduced in order to minimize the force required to lift the piston and reduce any risk of possible deformation of the orifice.

Furthermore, it is known from this publication that composite materials with a matrix of a polymer and with a FILLER of metal or ceramic can be used. The 3D printing for the production of a component from both metallic and ceramic pastes in one printing process is not known therefrom.

GB 2 521 913 A1 also discloses a heat exchanger which has several lines in the form of capillary tubes with a common inlet and outlet. It does not have a grid structure through which a fluid can flow and was not produced by a 3D printing process.

From the prior art, several problems arise when performing printing using 3D multi-material printing.

Before printing starts, the scaling of the extrusion quantity must be determined. Due to the tolerances of the pressure and dosing unit, it is not possible to exactly maintain the prescribed extrusion quantity according to the prior art. This inevitably has the consequence that the printed layers tend to be overfilled with printed material as the component height increases. If, on the other hand, too little material is introduced, the frequency of defects increases in proportion to the printing level.

In extrusion printing, defects can occur despite an optimized mixing process of the pastes. With large and complex printed bodies the probability of such events increases. According to the prior art, this means an interruption of the printing process, with subsequent manual correction. In unfavorable cases, this can also mean that the printing process is aborted. If a manual correction is possible, this will cause some problems when continuing the printing process. For example, changes in drying parameters and the re-setting of the printing machine can cause errors in the subsequent printing process.

Another problem of extrusion printing is the temporary blockage of the extrusion die. Clogging of the extrusion die cannot be completely ruled out due to statistical fluctuations in particle size and shape. If a blockage occurs, the printing process must be interrupted and the printed part cannot be finished. Manual cleaning of the nozzle is required to continue the printing.

According to the prior art, the dimensional stability of common binders during the printing process, the flowability, the segregation behavior, the hardenability and the compatibility to a sintering process are not given, because partly conflicting physical and chemical properties of the binder are required. Binders that meet all the requirements of 3D multi-material printing are not known from conventional methods. It is also necessary to adjust the binder properties depending on the size and shape of the particles in the paste.

According to the prior art, the pasty and granular containers are conveyed by means of compressed air or mechanically applied pressure. A disadvantage is that pastes that are under pressure for very long periods of time, as is necessary in 3D printing of large components, tend to segregate. This is especially true for pastes containing particles from materials with high densities such as metal.

Particularly with large to very large printing bodies, a defined curing must be guaranteed during the printing process, as otherwise the printing body may deform under its own load. In methods used so far, this is ensured by photo-curing or thermosetting polymers in the binder. However, this is not possible because of the special requirements for binders for 3D multi-material printing.

With regard to the sintering of a component, the prior art has disadvantages such that base metals such as copper or iron have to be sintered in an inert gas atmosphere or in the presence of active gases and, above all, in the absence of oxygen, otherwise oxidation processes occur which are contrary to an optimum sintering result. Under these conditions, however, not all binder constituents can be removed from the printing body, which has a negative effect on the desired properties of the printed part.

Copper and other metals cannot usually be permanently bonded on macroscopic scales because of the very different coefficients of thermal expansion. Enamel is an exception to this rule, but is not suitable for the manufacture of solid printing bodies. The LTCC (Low Temperature Cofired Ceramics) known from other processes have the required coefficients of thermal expansion, but are not suitable for 3D multi-material printing due to anisotropies of the coefficient of expansion.

### SUMMARY

It is the object of the invention to develop a device and a method for producing a component by means of 3D multi-material printing as well as an associated component which has a simple constructional structure and eliminates the aforementioned deficits of the prior art.

This object is solved with the characterizing features of the 1^{st}, 12^{th}, 13^{th}, 15^{th} and 18^{th} patent claim.

Advantageous embodiments result from the subclaims.

### DETAILED DESCRIPTION

The invention relates to a method for producing a component by means of 3D multi-material printing, in particular for producing an electrical component, wherein metallic and ceramic pastes are applied in layers by means of an extrusion process by means of an extrusion die and brought into shape. Several parameters during the printing process are monitored by a monitoring device.

By means of a monitoring device in the form of a camera, defects in the print are detected, located and compared with the measurements of a continuous monitoring system. Based on detected defects, new extrusion paths are automatically created which eliminate the defects fully automatically.

In addition, the same or an additional camera is used to monitor an overfilling or underfilling of each printed layer in relation to the extrusion quantity, wherein the degree of filling of each printed layer during the printing process is recorded and evaluated with the aid of imaging methods.

In a third monitoring process, temporary blockages in the extrusion die are detected by monitoring the pressure in the area of the extrusion die, wherein the blockage outside the printed body is released by increasing the pressure and the printing process is then continued. One advantageous possible measure is to interrupt the printing process and then move the print head to an area outside the printed body. In this area a defined amount of extrusion material is pressed out under increased pressure until the blockage is released. This process is advantageously carried out fully automatically.

To monitor defects in printing, it is advantageous to assess a bead placed on the printing body during the printing process with the help of the camera and image recognition and evaluation methods and, in the event of defects, to correct them before the next layer and/or the next material. Only when the defects have been corrected will printing of the next material or layer be continued. When a defect is detected, its location and extension are detected and stored. Based on detected defects, new extrusion paths are then automatically created, wherein the defects are eliminated fully automatically.

Furthermore, after the completion of a material in a layer, the corresponding area is recorded with the help of imaging techniques and the course of the extrusion paths is determined by means of an image recognition process.

To monitor the overfilling/underfilling of the extrusion quantity, the overfilling or underfilling is counteracted in an advantageous embodiment by means of the dynamic adaptation of a scaling factor in the form of a control loop to the printing process.

The loosening of the blockage in the extrusion die is preferably detected by means of a drop in the measured pressure, with the printing process continuing automatically afterwards. If the blockage cannot be removed by increasing the pressure, an error message is displayed to the user. The nozzle must then be cleaned manually, followed by a fully automatic setup of the print head and the continuation of the printing process.

According to the method, a special binder in the form of an emulsion of several components is used, wherein the emulsion is used to adjust the binder parameters in a targeted manner. The binder preferably consists of polymers of different chain lengths, ring-shaped hydrocarbon compounds, iso-parafins, olefins, n-parafins, emulsifiers, surface-active substances or defoamers or a combination of at least two of these components.

After the component has been printed, the printed parts are advantageously sintered. The temperature level and the sintering atmosphere are selected in such a way that the binder components are expelled from the component by oxidation in the oxygen-containing atmosphere. Subsequently, the temperature is increased to 900-1500° C., wherein the oxidized metallic components of the printed component are reduced with the aid of active gases. Sintering can be carried out using active gas or inert gas, wherein the oxide layers are removed under active gas.

According to the method, an automatic mixing and feeding device is used, wherein the metallic or ceramic paste is mixed under vacuum in the mixing and feeding device and fed to the print head by means of gravity and vibration. The vibrating movement changes the viscosity of the paste, so that it can leave the mixing container downwards, following gravity, through a conical shape with an opening into a transport hose.

The powder is conveyed into the mixing container by gravity and vibratory movements. The portioning is carried out via a variable inlet opening. From the amplitude, frequency, powder consistency and the diameter of the inlet opening, the quantity of material available for mixing can be determined, preferably by calculation using motion models.

The mixed-in binder is available in liquid form with a defined viscosity and can be dosed by means of conventional devices and fed into the mixing container. A vacuum is preferably present in the mixing container so that continuous deaeration of the paste can take place.

In an advantageous embodiment, the shrinkage values during the drying and sintering process as well as the physical properties of the printing body are adjusted by adding additives to the ceramic paste.

Furthermore, the invention relates to a device for producing a component by means of 3D multi-material printing, wherein metallic and ceramic pastes are applied by means of an extrusion process in layers by means of an extrusion die and brought into shape. The device comprises a mixing and feeding device and/or a building platform, wherein the mixing and feeding device comprises a mixing container placed under vacuum and is connected to a vibration device in such a way that the mixing container can be excited to vibrate, wherein the paste can be transported in the direction of the extrusion die by means of the vibrations. A vacuum is preferably present in the mixing container so that continuous deaeration of the paste can take place.

The mixing vessel contains an agitator and has a conical shape at the lower end. The mixing of the ceramic and metallic pastes in the mixing vessel is carried out by means of the agitator. The mixing vessel has a variable inlet opening for the supply of a powder and a supply for a binder.

The mixing container is preferably mechanically connected to a vibration device in such a way that it can be excited to vibrate at a variably adjustable frequency. The vibrating movement changes the viscosity of the paste, so that it can leave the mixing container, following gravity, downwards through the conical form, which contains an opening, into a transport hose.

The transport hose is preferably flexible to ensure a mechanical connection to the print head.

In order to ensure the transport of the paste caused by vibration, the transport hose is preferably equipped with further smaller vibration devices at defined intervals.

Furthermore, the device comprises the building platform in the form of a ceramic building platform, wherein the building platform has a porous structure such that moisture can be supplied to or removed from the component in a targeted manner. This allows the curing process to be specifically influenced during the printing process.

The building platform has an intrinsic structure, through which air and/or solvent can flow.

The ceramic paste used preferably consists of silicate ceramics. Alternatively, glass powder is added to the silicate ceramics.

Furthermore, the invention relates to a component which is manufactured by means of the method and device according to the invention, wherein the component has a grid structure. In an advantageous embodiment, the component is designed in the form of a heat exchanger. With the solution according to the invention, it is possible to print metallic pastes and ceramic pastes one after the other in a 3D printing process and thus to produce a part consisting of metallic and ceramic areas/components.

This ensures a high quality of the component, since the monitoring device can detect defects when printing a layer and correct them in this layer and/or the overfilling or underfilling is detected in a layer by detecting the filling level during the printing of the layer and/or by monitoring the pressure in the area of the extrusion die blockages of the extrusion die can be detected and solved by increasing the pressure. Each and every one of these measures of the monitoring system already leads to a higher reliability of the 3D printing process and an improvement of the component quality.

By mixing the pastes and the binder in a mixing vessel under vacuum, a deaeration of the paste is achieved, which also improves the printing quality and thus the quality of the component, since air inclusions in the printed ceramic and metal pastes are avoided. The additional application of vibrations to the mixing container facilitates the transport of the paste to the extrusion die.

Preferably, the metallic paste and the ceramic paste are each mixed from the corresponding powder and binder in a separate mixing vessel and fed to the respective extruder. It is therefore preferable to use a separate mixing container and a separate extruder for each material to be printed.

If a building platform with a porous structure is used in the device, moisture can be added or removed from the component in a targeted manner, which can influence the drying of the component.

The beads, which are arranged one above the other in a heat exchanger, are deposited in the respective one with a defined distance to each other. This allows the respective fluid to flow through the grid structure.

### BRIEF DESCRIPTION OF THE DRAWINGS

The invention is explained in more detail below using an embodiment example and associated drawings, wherein:

FIG. 1 shows a mixing and feeding device according to the invention,

FIG. 2 shows a porous ceramic building platform according to the invention,

FIG. 3 shows a sectional view of a heat exchanger produced with 3D multi-material printing,

FIG. 4 shows a heat exchanger manufactured by 3D printing,

FIG. 5 shows a heat exchanger with a “tube in tube” arrangement.

### DETAILED DESCRIPTION OF THE PREFERRED EMBODIMENTS

FIG. 1 shows an automatic and continuous mixing and feeding device for pastes for 3D multi-material printing. A powder 2 of metal or ceramic arranged in a storage vessel 1 is fed into a mixing vessel 3 with an agitator 4 concentrically arranged therein. The mixing container 3 has a conical shape at its lower end, which is connected to a transport hose 5 to the print head. The transport hose 5 has a flexible design and has vibration units 6 at defined intervals, which convey the ready mixed paste 7 by means of vibrations and the action of gravity in the direction of the print head.

The mixing vessel 3 has a drive motor 8 for the agitator 4 located in the mixing vessel 3. Since the mixing container is under vacuum, a connecting hose 9 is attached, which is connected to a vacuum pump. The vacuum thus generated causes continuous deaeration of the paste in mixing vessel 3.

A dosing and conveying device 10 is connected to the mixing container 3 via a further feed, which contains the binder or the individual components of the binder. The dosing and conveying device comprises a further connection for a connecting hose 11, which leads to a storage container for the binder. The dosing and conveying device 10 is connected to the mixing container 3 by means of a connecting hose 12. The binder is fed via this connection into mixing vessel 3.

The pastes are conveyed by vibration and gravity. The mixing container is preferably connected to a vibration device 14 by means of a mechanical connection 13 in such a way that it can be excited to vibrate at a variably adjustable frequency.

The vibrating movement changes the viscosity of the paste so that it can leave the mixing container 3, following gravity, downwards through the conical shape, which contains an opening, into the transport hose 5.

For 3D multi-material printing, the device has a separate mixing container 3 for mixing each paste to be printed. At least one ceramic and at least one metallic paste are mixed from powder and binder in a separate mixing vessel 3 each and fed from there via the transport hose 5 and an extruder 7.1 to the extrusion die 7.1, which is not separately designated, and thus the component is produced in one printing process.

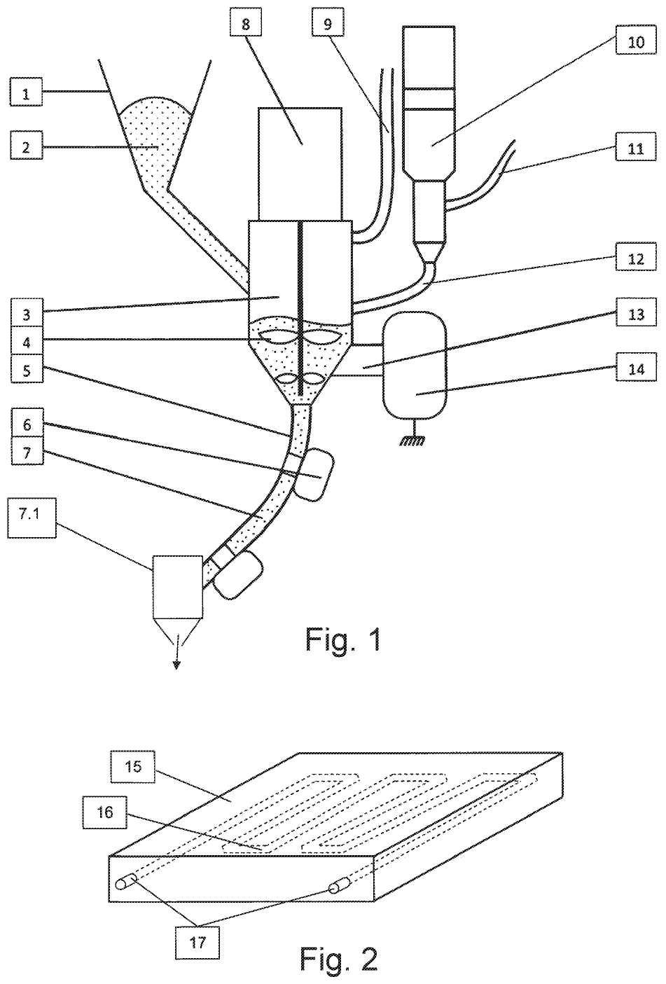

FIG. 2 shows a schematic representation of a porous ceramic building platform, which is used in the device according to the invention. The building platform 15 has a porous intrinsic structure 16 in such a way that moisture can be added or removed from the building component in a targeted manner. This allows the curing process to be specifically influenced during the printing process. Building platform 15 has connections 17, which allow air and/or solvent to flow through the building platform 15. The air and/or solvent can be supplied or removed via connection 17.

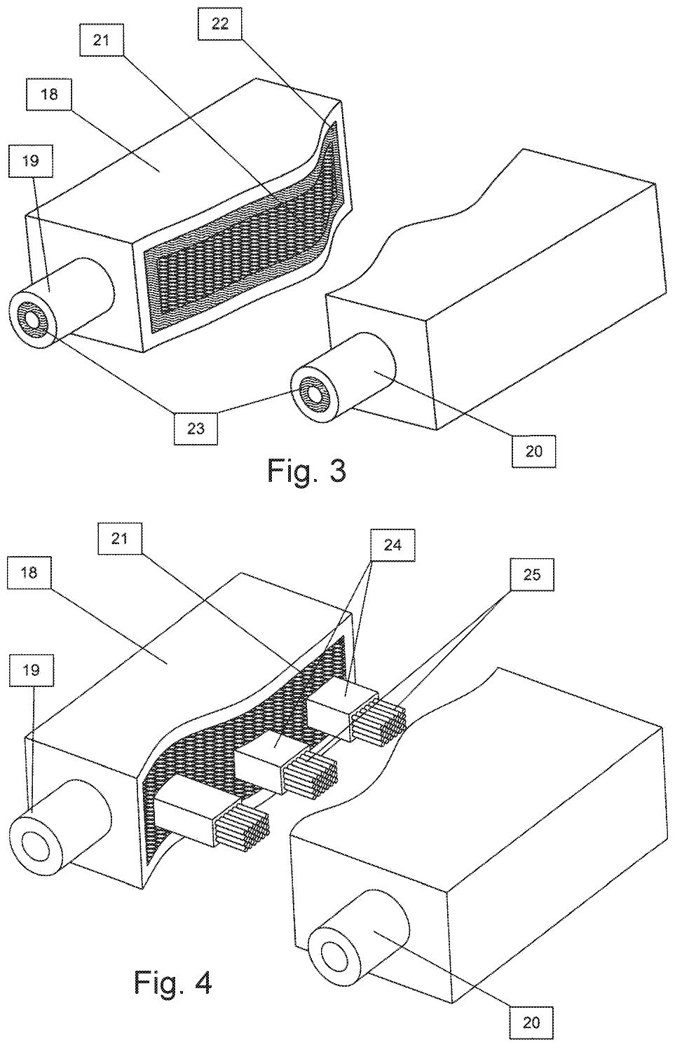

FIGS. 3 to 5 show various forms of heat exchanger design using 3D multi-material printing.

In principle, the heat exchangers shown in FIGS. 3 to 5 are comparable to standard heat exchangers in their external form.

The heat exchanger is completely 3D printed, wherein inner structure and different materials can also be implemented by means of printing. The heat exchanger consists of a housing 18, which can be equipped with mounting devices for power electronics, for example, as required. Furthermore, the heat exchanger has at least two connections on its front side in the form of an inflow 19 and an outflow 20. Inside the housing 18 is an inner structure in the form of an inner grid structure 21 for transferring the heat from the housing 18 to the cooling fluid.

According to FIG. 3, an additional insulation layer 22 is placed between the grid structure 21 and the housing 18 of the heat exchanger, wherein the insulation layer 22 can be made of a different material. This material can be stainless steel, for example, with chemical insulation of the housing (e.g. copper) against the fluid flowing through it, or ceramic is used as electrical insulation of the fluid flowing through against the housing. The connections in the form of inflow and outflow can also have an additional insulation layer 23.

According to FIG. 4, the heating elements 25 of the heat exchanger have a ceramic insulation 24 from the inner grid structure 21. This enables, for example, the pressure of a continuous flow heater with a high power density. The heating elements 25 are arranged in such a way that they are insulated from each other and from the fluid by the ceramic insulation layer 24.

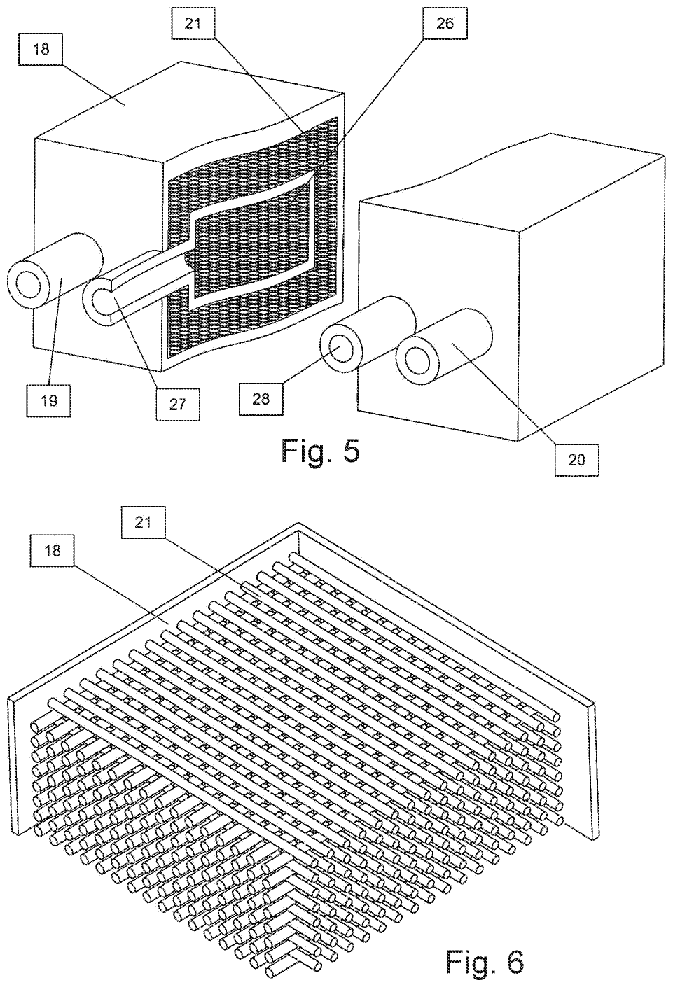

A heat exchanger with an intrinsic grid structure produced using 3D multi-material printing is shown in FIG. 5. Inside, a second fluid-carrying structure 26 is formed. The second structure 26 has a second inflow 27 and a second outflow 28, with the inflow and outflow 27, 28 serving as inlet and outlet for the inner fluid circuit. Thus, heat exchangers with high power density for hermetically separated systems, as well as several inner tubes are conceivable to increase the surface area.

FIG. 6 shows a detailed view of a grid structure 21 arranged in a housing 18, which was printed completely with housing 18.

After printing, heat treatment for hardening takes place in the form of sintering, wherein the binder is completely expelled.

The inner structure for transferring heat from the housing to the cooling fluid is fundamentally different from the known prior art.

Prior art are tube-like structures whose cross-section can also deviate from the round form.

The inner grid structure of the printed heat exchanger is created by extrusion of ceramic or metallic pastes, wherein beads are deposited in the respective plane with a defined distance between them.

Beads are also deposited by extrusion in the plane above, wherein they differ in their alignment to the beads below and have a defined distance from their neighboring beads in the plane. The angle between the alignment axes of superimposed beads can vary. The orientation of the beads alternates from layer to layer, creating a grid-like structure as shown in FIG. 6.

Since the grid and housing are made of the same material, e.g. copper, and with the same process (3D multi-material printing), a material bond is created between the grid structure, which transfers the heat to the cooling fluid and to the housing. The housing absorbs the heat from power electronics, for example. This results in a better heat transfer as there are significantly lower heat transfer resistances.

This leads to a significant increase in power density. In the case of geometric restrictions, the heat exchanger or heat sink can also be dimensioned smaller for the same power to be dissipated.

The grid structure produced by the method according to the invention can only be produced by 3D multi-material printing (extrusion printing), since from a certain degree of structural fineness, depending on the remaining opening, the remaining powder can no longer be removed in prior-art processes (powder bed process—laser melting and laser sintering).

The grid structure allows an optimum to be achieved in terms of the ratio between the surface through which heat can be exchanged and the volume through which fluid flows. At the same time, the housing can be designed to save material. Thus, grid structures with 3D multi-material printing can be produced very easily, quickly and in a material-saving manner.

A particular advantage of the printed heat exchanger is the external shape as well as the inner structure of the heat exchanger, which can be designed in practically any way. This allows integration into an environment with unfavorable space conditions.

Another advantage of using the 3D multi-material printing process is the possibility of using more than one material. The use of several materials thus results in a wide field of application.

According to the method, the housing of the grid structure, the grid structure itself and the outer housing need not be made of the same material. For example, the grid can be made of copper and the grid housing of ceramic. The outer housing can be made of stainless steel, for example.

Advantageously, the inner grid structure may contain printed ceramic insulated electrical conductors that serve as heating elements, as shown in FIG. 4. Furthermore, the inner grid structure may contain a structure that can also absorb a fluid. This structure also contains a grid structure in its interior. Such a “tube in tube” variant is shown in FIG. 5. A combination of the various embodiments from FIGS. 3 to 5 is also conceivable.

### LIST OF REFERENCE NUMERALS

1 Storage tank

2 Powder

3 Mixing container

4 Agitator

5 Transport hose

6 Vibration unit

7 Ready mixed paste

7.1 Extruder

8 Drive motor

9 Connection hose

10 Dosing and conveying device for the binder

11 Connecting hose to the storage container for binders

12 Connecting hose of dosing and mixing unit of the binder

13 Mechanical connection of vibration unit and mixing container

14 Vibration unit for mixing container

15 Building platform

16 Intrinsic structure

17 Connections for solvent and/or air

18 Housing

19 Inflow

20 Outflow

21 Inner grid structure

22 Insulation layer

23 Insulation layer inflow/outflow

24 Ceramic insulation layer

25 Heating element

26 Second grid structure

27 Second inflow

28 Second outflow

1. Method for producing a component by means of 3D multi-material printing, in particular for producing an electrical component, characterized in that by means of an extrusion process from powder and binder, mixed metallic and ceramic pastes for producing the component are applied in layers by means of an extrusion die and brought into shape, and that the printing process is monitored by means of a monitoring device in such a way that
by means of a camera, defects in the print are detected, localized and compared with the measurements of a continuous monitoring system, wherein, based on detected defects, new extrusion paths are automatically created which eliminate the defects fully automatically, and/or
by means of a camera, an overfilling or underfilling of each printed layer is monitored in relation to the extrusion quantity, wherein the degree of filling of each printed layer during the printing process is recorded and evaluated by means of imaging methods, and/or
temporary blockages in the extrusion die can be detected by monitoring the pressure in the area of the extrusion die, wherein the blockage outside the printed body is released by increasing the pressure and the printing process is then continued.

2. Method according to claim 1 for monitoring defects in printing, characterized in that a bead deposited on the printing body during the printing process is evaluated with the aid of the camera and image recognition and evaluation methods and, in the case of defects, these are eliminated before the next layer and/or the next material.

3. Method according to claim 1 for monitoring defects, characterized in that, after completion of a material in a layer, the corresponding area is detected with the aid of the imaging materials and the course of the extrusion paths is determined by means of an image recognition method.

4. Method according to claim 1 for monitoring the overfilling/underfilling of the extrusion quantity, characterized in that the overfilling or underfilling is counteracted by means of the dynamic adaptation of a scaling factor in the form of a control loop to the printing process.

5. Method according to claim 1, in that the loosening of the blockage of the extrusion die is detected by means of the drop in the measured pressure.

6. Method according to claim 1, characterized in that a binder in the form of an emulsion of several components is used, wherein the emulsion is used for the targeted adjustment of the binder parameters.

7. Method according to claim 6, characterized in that the binder consists of polymers of different chain length, ring-shaped hydrocarbon compounds, iso-parafins, olefins, n-parafins, polysaccharides, surface-active substances or defoamers or a combination of at least two of these components.

8. Method according to claim 1, characterized in that after the component has been printed, a sintering process of the printed parts takes place, wherein the temperature level and the sintering atmosphere are selected in such a way that the binder components are expelled from the component by means of oxidation, wherein the temperature subsequently is increased to 900-1500° C., wherein the oxidized metallic components of the printed component are reduced with the aid of active gases.

9. Method according to claim 1, characterized in that by means of an automatic mixing and feeding device the metallic and ceramic paste is mixed under vacuum and fed to the print head by means of gravity and vibration.

10. Method according to claim 9, characterized in that the mixing and feeding device has an inlet opening, wherein the quantity provided for mixing is determined from the amplitude, frequency, powder consistency and diameter of the inlet opening.

11. Method according to claim 1, characterized in that by adding additives to the ceramic paste the shrinkage value during the drying and sintering process as well as the physical properties of the printing body are adjusted.

12. Device for producing a component by means of 3D multi-material printing, characterized in that mixed metallic and ceramic pastes for producing the component can be applied in layers by means of an extrusion die and brought into shape by means of an extrusion process from powder and binder, comprising a monitoring device for monitoring the printing process, wherein the monitoring device
has a camera which detects and localizes defects in the print and compares them with the measurements of a continuous monitoring system, and/or
has means for monitoring a print to detect temporary blockages in the area of the extrusion die and that the blockage outside the printed body can be released by increasing the pressure and the printing process can be continued, and/or
has a camera monitoring the overfilling or underfilling of each printed layer in relation to the extrusion quantity, and the degree of filling of each printed layer during the printing process can be recorded and evaluated by means of an imaging method.

13. Device for producing a component by means of 3D multi-material printing, characterized in that by means of an extrusion process from powder and binder, mixed metallic and ceramic pastes for producing the component can be applied in layers by means of an extrusion die and brought into shape with a mixing and feeding device, characterized in that the mixing and feeding device comprises a mixing container under vacuum and is connected to a vibration device in such a way that the mixing container can be excited to vibrate, wherein the paste is transportable in the direction of the extrusion die by means of the vibrations.

14. Device according to claim 13, characterized in that the mixing of the ceramic and metallic pastes in the mixing vessel is carried out by means of an agitator, wherein the mixing vessel has a variable inlet opening for the supply of a powder and a supply for a binder.

15. Device for producing a component by means of 3D multi-material printing, characterized in that by means of an extrusion process of powder and binder, mixed metallic and ceramic pastes for producing the component can be applied in layers by means of an extrusion die and brought into shape, wherein the device comprises a building platform and the building platform is designed in the form of a ceramic building platform, wherein the building platform has a porous structure in such a way that moisture can be supplied to or removed from the component in a targeted manner.

16. Device according to claim 15, characterized in that the building platform has an intrinsic structure, wherein air and/or solvent can flow through said structure.

17. Device according to claim 12, characterized in that the ceramic paste preferably consists of silicate ceramics and/or that glass powder and/or technical ceramics are added to the silicate ceramics.

18. Component, produced with the method according to claim 1 and the device according to claim 12, characterized in that the component has a grid structure of beads which are deposited in a plane at a distance from one another, wherein beads are also deposited by extrusion in the plane above, wherein said beads differ in their alignment with the beads below and are at a distance from their adjacent beads in the plane.

19. Component according to claim 19, characterized in that the component is designed in the form of a heat exchanger.
